(19) United States
(12) Patent Application Publication
(10) Pub. No.: US 2005/0149350 A1
(43) Pub. Date: Jul. 7, 2005

(54) Patient information management system and method

(76) Inventors: Roger S. Kerr, Brockport, NY (US); Timothy J. Tredwell, Fairport, NY (US)

Correspondence Address: Mark G. Bocchetti;Patent Legal Staff, Eastman Kodak Company, 343 State Street, Rochester, NY, 14650-2201, US

(21) Appl. No.: 10/745,917

(22) Filed: Dec. 24, 2003

(51) Int. Cl. G06F 17/60

(52) U.S. Cl. 705/2

(57) ABSTRACT

A patient information management system and method form managing patient information is provided. A first identifier for storing patient identification data in a remotely readable form and a second identifier associated with a medical device for storing patient medical information in a remotely readable form are provided. At least one reader remotely reads data stored in the first and second identifiers and communicates this data to an external database.

### FIELD OF THE INVENTION

This invention generally relates to patient information management systems, and is specifically concerned with a system that utilizes multiple radio frequency transponders to manage patient information from admission to discharge from a health care facility.

### BACKGROUND OF THE INVENTION

Networked information systems such as HIS (Hospital Information Systems) provide some measure of effective information management for medical data of patients admitted to hospitals or receiving outpatient care. Textual data can be readily stored and accessed using networked computer systems that serve a multitude of functions from billing to patient records maintenance. However, because medical images are obtained by various types of equipment using a variety of different exposure and development techniques and can be provided on different types of media, the management of medical images poses some difficulties. Even though many imaging techniques can now provide digital image data, there remains a recognized need for more efficient ways of maintaining and managing hardcopy medical images and for associating these images to the complete set of patient data. It is vital for effective patient care that the correct images needed to diagnose and treat a patient's condition be obtained, that the images are positively identified so that there is minimal chance of confusion due to mismatched images, and that images be correlated with other data about the patient. It is also important that patient privacy be properly maintained, with checks on authorization and security that help to ensure privacy and help to obtain the proper medical care, without jeopardizing the quality and timeliness.

Various methods have been described in the art of improving identification methods for tagging X-ray plates used in forming diagnostic images. For example, U.S. Pat. No. 5,757,021 (Dewaele) discloses a system and method for tracking and identifying X-ray images provided for a patient by attaching a radio frequency identification transponder tag to the X-ray photo-cassette. Such Radio frequency identification transponder tags are known in the art as Radio Frequency Identification (RFID) tags. The '021 disclosure is directed primarily to CR (Computed Radiography) media, in which a photostimulable phosphor in the cassette records exposure energy from the original X-ray scan for subsequent conversion to digital image data. In order to associate a particular image with a specific patient, the radio frequency transponder in the cassette stores identifying information. To provide more accurate image processing, the radio frequency transponder also stores information about the type of image(s) obtained. In the '021 scheme, the patient has a bar code identifier that is unique, associated with the radio frequency transponder, and provides a link into the HIS or Radiologic Information System (RIS) database.

U.S. Pat. No. 6,271,536 (Buytaert et al.) also discloses writing various patient identification and image specification data to a radio frequency transponder attached to an X-ray cassette of the CR type. In addition, the '536 disclosure also attempts to address the problem of authorization, allowing only specific medical personnel to view images obtained, where medical personnel are themselves provided with a radio frequency transponder or similar identifier. Once an image is printed or written to film, however, conventional patient identification methods are applied and no authorization checks or viewer tracking are performed.

U.S. Pat. No. 6,047,257 (Dewaele) discloses an identification station which encodes audio data into a memory attached to an X-ray cassette, allowing voice-based data entry for identifying a cassette to be processed for subsequently forming an image onto film or paper media and for storing medical information for the patient associated with an image.

While this art provides some degree of correlation between medical data and a patient allowing storage of some amount of patient data, there is felt to be significant room for improvement. Solutions that provide the following would be of particular interest:
(1) Long-term identification of the image. Current methods such as those disclosed in the '021, '536, and '257 patents are directed to storing the patient's name and other identifying information on a cassette used to capture diagnostic image data. However, once the image is obtained, it may be printed subsequently onto film or onto opaque media. Methods are needed for coupling patient identification and relevant medical data to an image that is subsequently printed.
(2) Creation and maintenance of a central database for storing comprehensive medical data. The diagnostic image obtained is typically only one record among many for any individual patient. Thus, it would be desirable to be able to store and access, in a single file, all relevant records for a patient, including images. However, existing methods for medical image storage are more narrowly focused on image-to-patient identification and can be manually intensive. For hospitals, using an electronic file maintained for each patient would also allow improved tracking of patient history from admission to discharge phases. In some countries, for example, medical records and images themselves are provided to the patient as a hardcopy file, following treatment, rather than being stored by the medical facility. Where this is the practice, some method for linking an image to other diagnostic and treatment data would be of value, particularly where different doctors or other medical professionals work with the same patient at a date later than that at which the image was obtained.
(3) Tracking history for each medical practitioner who has been in contact with patient at each stage of admission, diagnosis, and treatment. This feature would make sure that the patient was attended by specialists having appropriate disciplines and would allow individual practitioners to determine the best course of action for treatment. This capability includes providing a tracking history for who has accessed or viewed images or file data for the patient and how many times an image has been accessed and viewed. This tracking history may be linked with a system that restricts information based on the role of the image or file data viewer. Improved security and better tools for providing patient privacy would be among the benefits of such a tracking utility.
(4) Tracking of medical devices and supplies such as consumables and medicines used to treat a patient. This feature would be useful not only in informing medical personnel of previous treatments, but also in tracking expenses for billing purposes.

These added features would provide the overall advantages of improved traceability and better management of images, supporting more efficient and accurate diagnosis and treatment.

### SUMMARY OF THE INVENTION

In one aspect of the invention, a patient information management system is provided. The patient information management system comprises, a first identifier for storing patient identification data in a remotely readable form; a second identifier associated with a medical device for storing patient medical information in a remotely readable form, and at least one reader for remotely reading data stored in the first and second identifiers and communicating this data to an external database.

In another aspect of the invention, a patient information management system is provided. The patient information management system has a patient identifier including a radio frequency transponder storing patient identification data, a medical device including an radio frequency transponder for storing patient medical information, and at least one reader for remotely reading data stored in said radio frequency transponder for said patient identifier and said medical device and communicating said data to an external networked database.

In still another aspect of the invention a method for managing patient information is provided. According to the method a patient is provided with a patient identifier that stores patient identification information in a remotely readable form and diagnosis data is recorded for the patient in an identifier in a remotely readable form. The data recorded in said identifiers is read and the patient identification data is stored in association with the diagnosis data in a memory.

### BRIEF DESCRIPTION OF THE DRAWINGS

FIG. 1 is an overview block diagram showing typical stages for treatment of a patient requiring an image;

FIG. 2 is a block diagram showing finctional components for an implementation of the present invention in an initial evaluation/admissions stage;

FIG. 3 is a block diagram showing functional components for an implementation of the present invention in an image capture stage;

FIG. 4 is a block diagram showing functional components for an implementation of the present invention in an image processing stage;

FIG. 5 is a block diagram showing functional components for an implementation of the present invention in a diagnosis stage;

FIG. 6 is a block diagram showing functional components for an implementation of the present invention in a treatment/discharge stage;

FIG. 7 is a block diagram showing functional components for an implementation of the present invention in image archival;

FIG. 8 is a block diagram showing components of a folder of medical records for a patient;

FIG. 9 is a block diagram showing functional components for implementation of the present invention at an accident scene; and,

FIG. 10 is a block diagram showing the basic components of a digital light box.

### DETAILED DESCRIPTION OF THE INVENTION

Overview

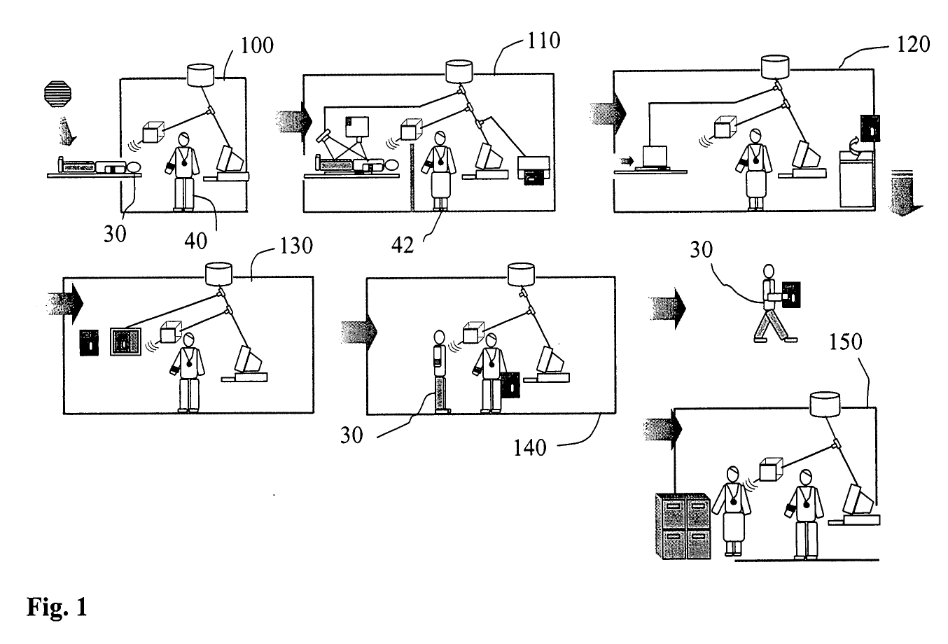

FIG. 1 shows an overview of the general phases in a typical treatment cycle where an image is obtained as part of the cycle. In an initial evaluation/admissions stage (100), a patient (30) has first contact with a medical professional (40). Initial information is obtained about the patient's condition. Preliminary decisions are made concerning needed images and an assessment of likely treatment stages is made. In a diagnostic image capture stage (110), an imaging specialist (42) obtains the needed images as requested during the preceding stage. In a subsequent image processing stage (120), images are prepared for viewing and diagnosis in following stages. In a diagnosis stage (130), images obtained and processed in the preceding steps are analyzed and diagnostic assessment is performed. In a treatment stage (140), the patient (30) is treated appropriately for the illness or injury. Then, patient (30) is released. An archival stage (150) then provides archival storage of medical records and images obtained for this patient (30).

During each of the stages in FIG. 1, information is obtained in some form, whether image, verbal, metric (such as body temperature or blood pressure), or in some other form, and is needed for proper functioning of stages that follow. In addition to conventional paper files, a memory in some form supports each stage; this may be a separate database for each stage or may be a networked database that is associated with patient (30) and with patient data during each stage.

As indicated in the background description given earlier, there are a number of existing systems that provide information supporting the stages shown in FIG. 1. However, conventional methods for providing and storing all of the needed data for effective treatment of patient (30) fall short of providing a full-fledged information and image management system that fully supports all of these stages.

Initial Evaluation/Admissions Stage (100)

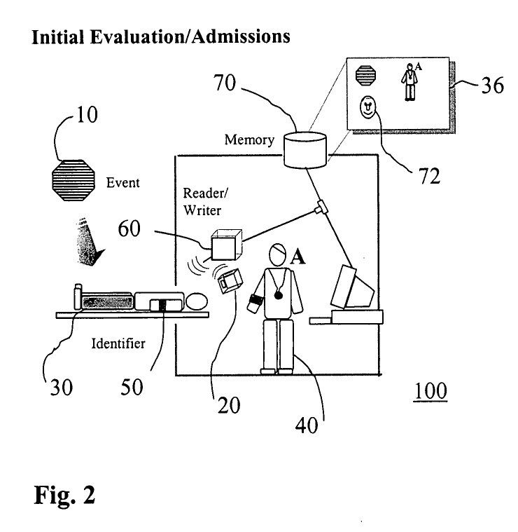

FIG. 2 shows initial evaluation/admissions stage (100) in greater detail. Patient (30) enters this stage as a result of some event (10), such as an accident, symptom, referral, or test results, for example. Medical professional (40) has initial contact with patient (30) to obtain essential identifying information and to obtain any available information regarding event (10) that is available. Depending on the nature of the illness or injury event, medical professional (40) may be, for example, an ambulance attendant, nurse, physician, or therapist. The location of this first contact could be at an accident or injury site or at a medical facility, for example. It will be appreciated that the information that is initially obtained can be highly important, particularly in cases where medical treatment is needed for acute medical conditions such as in the case of an accident or injury or in other types of emergency situation.

In order to store and track this initial description and initial assessment of the patient's condition, patient (30) is associated with an identifier (50) such as a barcode tag, a radio frequency transponder, or other identifier (50). A reader (60) reads this identifier (50) and stores the initial information obtained in a memory (70) in a manner that is logically associated with identifier (50).

Memory (70) itself may be stored as part of identifier (50), such as in a memory (70) that is built into a radio frequency transponder, for example. A corresponding paper file (36) also includes patient data; memory (70) contains some or all of the information content of paper file 46. In the embodiment of FIG. 2, identifier (50) provides a link to a unique location allocated for information about the patient in an external, networked database, such as an ORACLE database from Oracle Corporation, for example. Information that can be stored in memory (70) can include but is not limited to the following:

(1) a incident description data characterizing the initiating event (10). This may be in the form of text data or may be encoded audio data obtained from the patient or from medical professional (40). The verbal description may include a dialog between patient (30) and medical professional (40), with questions and answers to describe the condition of patient (30) at the time of this initial evaluation.

(2) patient identifying data. This can include textual data, such as name, address, medical insurance number, for patient (30) and the like. For quick identification throughout subsequent treatment, this identifying data can include a photograph (72) showing the face of the patient, as described subsequently. In one embodiment of the invention, the patient identifying data can be obtained from a patient identifier 50 such as an insurance token or card having a radio frequency transponder therein that can be used to identify the patient, his or her, medical insurance provider and other information that can be useful in medical treatment of patient (30).

(3) medical professional identifying data about medical professionals (40) who have had contact with the patient. This data can be used to assure efficient tracking of patient history and to maintain a record of information provided to patient (30) throughout this stage. In one embodiment of the invention, each medical professional(40) treating patient (30) can be associated with an identifier (50) such as an identification badge having a radio frequency transponder therein that can be used to identify the medical professional.

(4) diagnostic data identifying the patient's medical condition including but not limited to vital signs such as heart rate, temperature, electrocardiograph information, respiratory information, X-ray images, such as those that can be obtained from portable computed radiography (CR) imaging equipment, and other patient related information that can be used for diagnosing problems and determining a course of treatment. In one embodiment of the invention, medical devices used for patient examination and monitoring provide information such as by using a radio frequency transponder to identify the device and to provide data obtained therefrom for use in medical treatment of patient (30), or for other purposes.

(5) treatment data identifying medical procedures and medicines applied to the patient at the scene or en route to a hospital or other facility. In one embodiment of the invention, medical devices, pharmaceutical sources, including but not limited to intravenous or other supplies of medicines, to pain reducers and the like, packages of medicine and other consumables used for patient treatment and monitoring of the patient, such as bandages, fluids and the like, a radio frequency transponder to identify when such medical devices, pharmaceutical sources, medicines and consumables have been used in medical treatment of patient (30).

Depending on the type of event (10) that motivates treatment, a digital camera (20) may be of particular value for treatment and record-keeping. Digital camera (20) may simply provide photograph (72) of patient (30) for quick identification purposes, as described above. For some types of event (10) such as accidents and emergencies, digital camera (20) may have a more significant diagnostic function. For example, an ambulance team arriving at an accident scene can routinely capture an image showing the position or condition of patient (30) before being moved or as emergency aid is administered.

In an emergency situation, event description data, patient identifying data, medical professional identifying data, diagnostic data, treatment data, photograph (72) and/or other information obtained at the location of an event (10) can be electronically sent ahead to a hospital or other treatment facility prior to bringing patient (30) in for treatment. The same reader (60) used for communication with identifiers 50 can be used for such communication. However, a separate reader/transmitter apparatus can be used for sending such data, as is well known in the communication and telecommunication arts. In life-threatening situations, or other cases of acute illness, transmitted information sent from the scene or from an ambulance vehicle during transport can be used to enable interactive communication between, such as, an emergency vehicle and hospital staff.

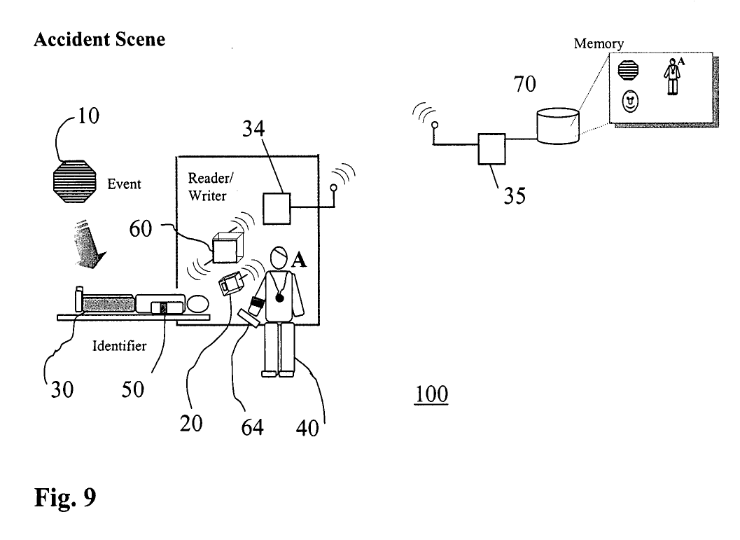

Referring to FIG. 9, there is shown a more detailed block diagram of initial evaluation/admissions stage (100) components for mobile accident, emergency, and rescue environments. A transmitter (34) is provided with equipment at the accident site for transmitting image information and other data obtained from digital camera (20), reader (60), and an optional portable data entry console (64), which might comprise a keyboard, a microphone, or other device for obtaining descriptive data from medical professional (40), patient (30), and others at the site. At the receiving site, a receiver (35) accepts the transmitted data such as the image information captured by camera 70 and stores it in memory (70) for access. This data, received in the advance of the arrival of patient (30), allows a hospital or other facility to prepare for the arrival of patient (30), such as readying equipment and alerting the needed personnel and specialists, for example. This data can also be used to facilitate and speed admissions processing so that the hospital or other medical facility receiving such information can rapidly and efficiently admit and begin treatment of person (50).

Image Capture Stage (110)

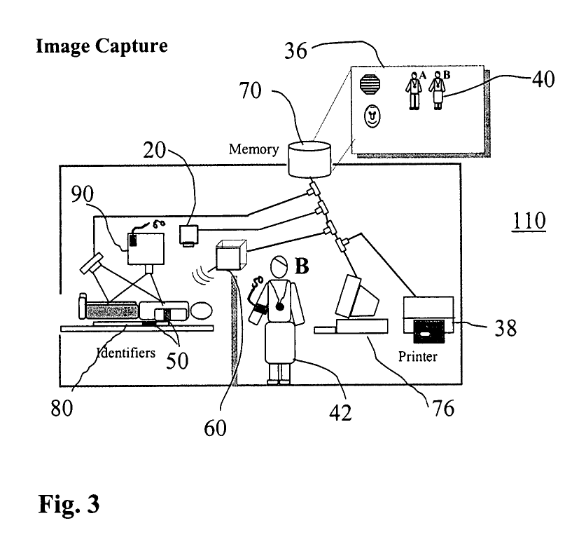

Based on decisions made during initial evaluation/admissions stage (100) of FIG. 2, patient (30) next undergoes a diagnostic image capture stage (110), as shown in FIG. 3. In this stage, an X-ray, ultrasound, or other type of medical image (74) is obtained. In the embodiment of FIG. 3, a CR plate (80) is exposed and used for obtaining a medical image (74) comprising an X-ray image. Medical image (74) can be previewed at a workstation (76) and or, optionally, printed by a hardcopy printer (38).

Information about imaging conditions during an exposure may be obtained, such as imaging equipment (90) unit and type, settings or adjustments, and other data and stored in memory (70) in association. It is also vital that any obtained medical images (74) be properly identified, so that mismatch of medical images (74) does not occur. In order to store and track this information, identifiers (50) are attached to patient (30), to the imaging medium such as CR plate (80), to imaging equipment (90), and to the imaging specialists (42) who operate equipment (90). Identifiers (50) shown in the embodiment of FIG. 3 each include a radio frequency transponder, provided for example as part of an identification bracelet. Another type of identifier (50) could be used, such as a barcode tag, for example. Reader (60) reads this identifier (50) and stores the information obtained regarding an exposure in memory (70), logically associated with identifier (50). Memory (70) itself may be stored as part of identifier (50), such as in a memory (70) that is built into a radio frequency transponder, for example. In the embodiment of FIG. 3, identifier (50) provides a link to a unique location allocated for information about the patient in an external, networked memory (70) comprising a database, such as an ORACLE database from Oracle Corporation, for example. Information added to memory (70) during this stage can include but is not limited to the following:

(1) a verbal record of the image capture session. This may be in the form of text data or may be encoded audio data obtained from imaging specialist (42).

(2) information about the image capture session, including equipment and settings used. This information may also include image data, in thumbnail form, from the image capture session.

(3) medical professional (40) identifying data, identifying medical professionals (40) who have had contact with patient (30) during imaging (indicated by letters A, B in FIG. 3).

(4) other useful data, such as data indicating an accumulated level of radiation received by patient (30) or by an individual medical professional (40).

The identifier (50) on CR plate (80) enables positive identification of the latent image that is formed thereon. Other information about the imaging conditions may also be stored on the identifier (50) associated with CR plate (80). Identifier (50) may be embedded within or attached to CR plate (80).

In the image capture stage of FIG. 3 and in other stages, the medical professional (40) identifying data can comprise data that identifies medical professionals (40), such as those indicated at A, and B in FIG. 3 and indicated with subsequent alphabetical designators in figures that follow, who have attended to patient (30) both in direct contact as well as in viewing diagnostic images or in reviewing or handling medical information on-line or in paper file (36).

Image Processing Stage (120)

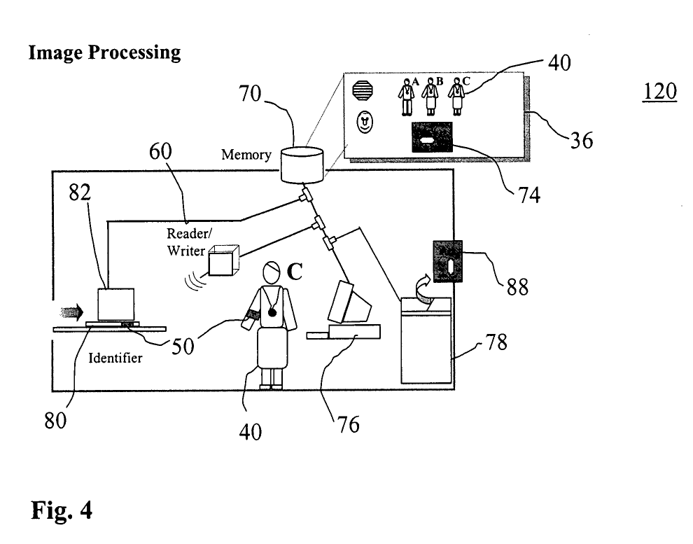

Following the image capture stage of FIG. 3, an optional image processing stage takes place, as shown in FIG. 4. In the embodiment shown, CR plate (80) is read by a digitizer (82) (which may be a part of a printer (78)) in order to obtain medical image (74) generated during the X-ray scan. CR plate (80) can then be erased and reused, once medical image (74) is stored. Advantageously, the transponder used as identifier (50) associated with CR plate (80) can also be erased to allow re-use.

Information about image processing conditions may be obtained for example, from memory (70) that indicates the specific image processing equipment and algorithms, settings and adjustments, used by such equipment and other data. A hardcopy print (88) can be provided at printer (78). A “soft” view of the image can be provided on the display screen of a workstation (76).

Identifiers (50) are described generally herein as are radio frequency transponders. These radio frequency transponders are provided in suitable form for each person, unit of equipment, pharmaceutical source, medicine, medical device or consumable used in the treatment and care of patient (30). The described used of a radio frequency transponder for this purpose is not limiting. Another type of identifier (50) could be used, such as a barcode tag, for example.

Reader (60) reads identifier (50) and stores the information obtained in memory (70) in a manner that is logically associated with identifier (50). As for earlier stages, memory (70) itself may be stored as part of identifier (50), such as in a memory (70) that is built into a radio frequency transponder, for example. In the embodiment of FIG. 4, identifier (50) provides a link to a unique location allocated for information about the patient in an external, networked memory (70) having a database, such as an ORACLE database from Oracle Corporation, for example. Information added to memory (70) at this stage can include any or all of the following:

(1) a verbal record of the image processing session. This may be in the form of text data or may be encoded audio data obtained from medical professional (40);

(2) information about the image processing session, including equipment and settings used;

(3) medical professional(s) 40 involved with processing the patient (30) image; and

(4) image data, at full resolution and in thumbnail form, for printing or display.

As a result of this processing, the image is made available in both hard- and soft-copy forms. One or more identifiers (50) can be added to hard copy output print (88). This identifier (50) may contain memory information about the image thereon or may provide a link to external memory (70) containing this information.

While a CR plate (80) embodiment is shown, it is important to note that imaging and processing information could also be stored by means of identifier (50) associated with a conventional X-ray film or with some other type of imaging medium.

Diagnosis Stage (130)

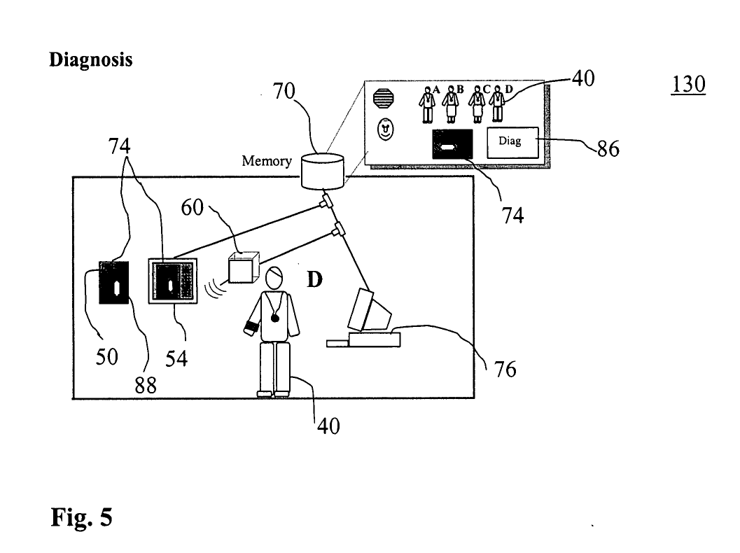

Once the image is processed, it can be used as a diagnostic tool. Referring to FIG. 5, there is shown how identifier (50) coupled with memory (70) is used during this process. Medical professional (40) obtains medical images (74) for patient (30), either on workstation (76) display or as hard-copy output print (88). Optionally, medical images (74) can be displayed on a digital light box (54), described subsequently in more detail.

Identifier (50) is provided on hard-copy output print (88) for associating image 74 correctly with a specific patient (30). A suitable identifier (50) for use with a sheet of imaging material might be a TAG-IT type radio frequency transponder of the type sold by Texas Instruments, Dallas, Tex., USA, for example. In the embodiment of FIG. 5, identifier (50) provides a link to a unique location allocated for information about patient (30) in an external, networked database, such as an ORACLE database from Oracle Corporation, for example. Information that can be added to memory (70) at this stage includes the following:

(1) a detailed record of diagnosis (86). This may be in the form of text data or may be encoded audio data obtained from medical professional (40).

(2) information about diagnosis (86).

(3) medical professional(s) (40) who have had contact with patient (30) or with patient records or were consulted when formulating diagnosis (86).

One or more identifiers (50) may be used to provide image orientation information, so that each medical image is correctly interpreted during diagnosis.

An identifier (50) provided with a medical image (74) can be used to record access times and to maintain a listing of individuals who view medical image (74). A photodiode (not shown) could be coupled to identifier (50) on hardcopy output print (88). Light sensed by the photodiode would allow power for counting the number of times medical image (74) is placed under bright light reading conditions, for example, with the counted number of exposures being maintained in a form that is readable by reader (60).

Treatment/Discharge Stage 140

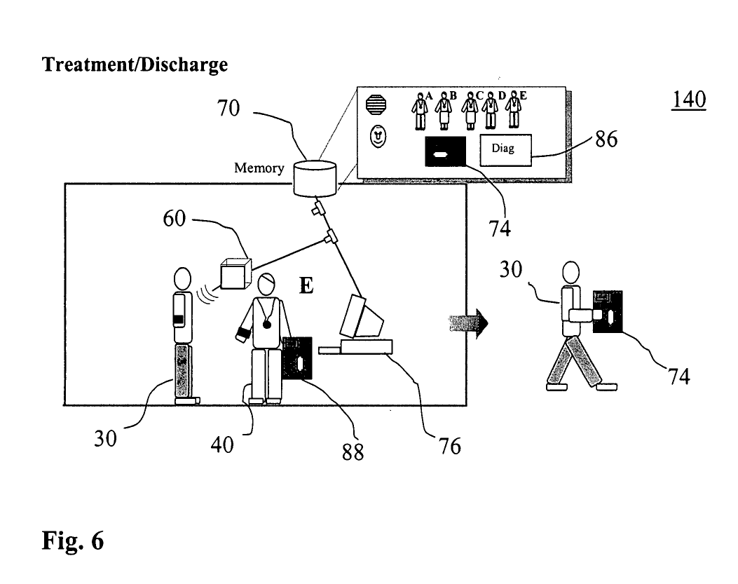

FIG. 6 illustrates how identifiers (50) and memory (70) can be used to facilitate a serve treatment/discharge stage 140. During treatment, medical professionals 40 obtain the data for patient (30) such as a medical image (74), either on a workstation (76) display or as hard-copy output print (88). Identifier (50) is provided as hard-copy output print 88 for associating medical image (74) correctly with a specific patient (30). A suitable identifier (50) for use with a sheet of imaging material might be a TAG-IT inlay radio frequency transponder, for example. In the embodiment of FIG. 6, identifier (50) provides a link to a unique location allocated for information about patient (30) in external, networked memory (70) operating a database, such as an ORACLE database from Oracle Corporation, for example. Information added to memory (70) during treatment/discharge can include any of the following:

(1) a detailed record of treatment steps. This may be in the form of text data or may be encoded audio data obtained from medical professional (40). Alternately, this record could include recorded dialogue with patient (30).

(2) information about the diagnosis and the treatment received such as information that indicates information such as the procedures performed, the medical devices used, the pharmaceutical source provided, the consumables used, and the vital signs of the patient (30) during the procedure.

(3) medical professional(s) (40) who have had contact with patient (30) or with patient records or were consulted during treatment.

(4) Any and all data obtained during the course and treatment of patient (30).

At any suitable time, such as at the conclusion of treatment, patient (30) can be provided a copy of any medical images (74) of particular interest. A record identifier (50) can be provided on such a copy for verification purposes.

Annotation/Archival

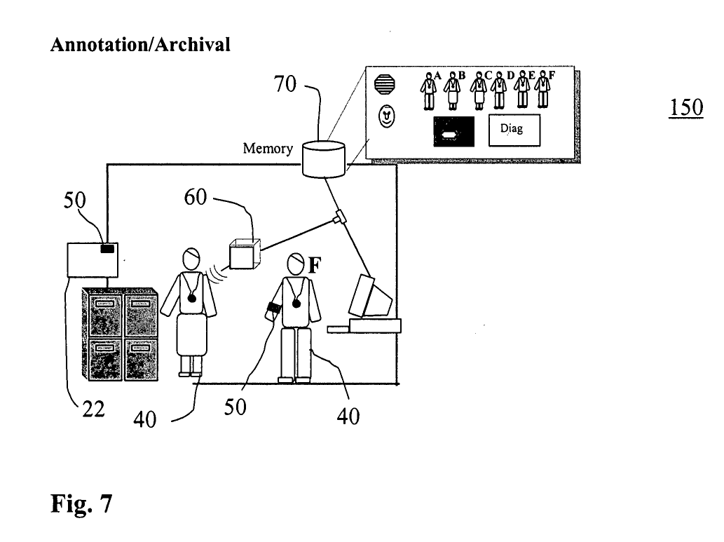

Referring to FIG. 7, there is shown how identifiers logically associated with memory (70) serve medical record annotation and archival (150). Utilizing one or more identifiers 50 as part of the stored medical image (74), the method of the present invention provides considerable data that can be used for historical and forensic purposes, with added potential for research and teaching, for example.

In the embodiment of FIG. 7, identifier (50) provides a link to a unique location allocated for information about patient (30) in an external, networked memory (70) having a database, such as an ORACLE database from Oracle Corporation, for example. Information provided at this stage and stored within memory (70) can include the following:

(1) a detailed record from admission, through diagnosis, treatment, and release. This may be in the form of text data or may be encoded audio data obtained from medical professionals (40) or from dialogue between the medical professional (40) and patient (30).

(2) information about all medical professional(s) (40) who had contact with patient (30) during any stages of the treatment cycle of FIG. 1.

(3) high-resolution and low-resolution image data.

(4) photograph of the patient for identification.

(5) complete patient records information.

Use of a radio frequency transponder as identifier has particular advantages for archival of medical images, including ease of inventory. Where thousands of folders 22 containing medical images 74 can be stored in one location, radio frequency transponder addressing and identification schemes simplify cataloging of these stored records. Misfiled or lost records can be more easily found when radio frequency transponders are used as identifiers.

As is shown in FIGS. 2-7 memory (70) accumulates historical data (71) as patient is treated and discharged. Any and all of the data obtained during diagnosis treatment of patient (30) can be tracked. This data (71) can be used for further treatment of the patient (30) and for historical evaluation purposes including but not limited to epidemiological investigations.

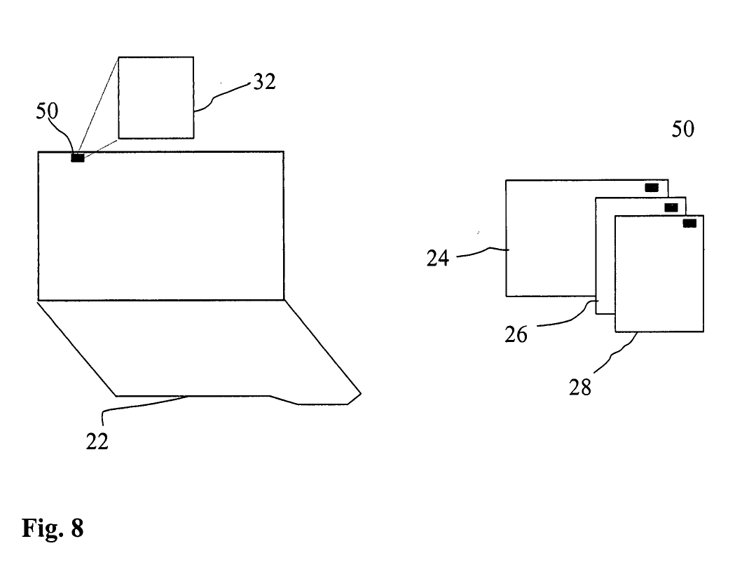

Referring to FIG. 8, folder (22) may itself have multiple documents from other sources, including an X-ray (24) or other diagnostic image, an admissions report (26), and a lab report (28), as just a few examples. Each document is, in turn, provided with an unique identifier (50). A table of contents (32) is maintained on identifier (50) that is provided with folder (22), listing the other documents that are also contained therein. With such an arrangement, folder (22) can be readily electronically queried to identify its contents and each document in turn can be polled to determine whether it properly belongs in folder (22). This would help to determine that folder (22) is complete and may also provide methods for finding lost and missing documents for a folder (22).

For each of the stages shown in FIGS. 1-7, it must be emphasized that memory (70) can be stored at a number of different locations. Some types of identifier (50), such as the radio frequency transponder (70), have capacity for on-board memory, allowing at least part of memory (70) contents to be stored on a print, for example. Use of an external memory (70) has the advantage of straightforward interface with other information systems that support health-imaging applications, such as PACS, RIS, and HIS.

Digital Light Box (54)

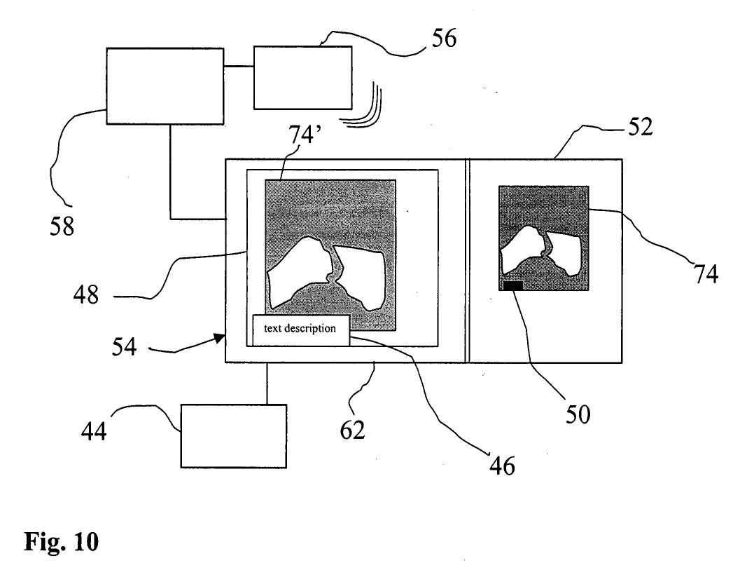

Referring to FIG. 10, there is shown an arrangement of components for digital light box (54). Digital light box (54) has a backlight portion (52) for conventional light box display of image 74 on film. An electronic display portion (62) provides a display screen (48) showing the image data obtained as image (74′). Display screen (48) provides menu selections and other features for obtaining or providing information, including a text window (46) for entry or review of text data, such as from keyboard console (44).

Digital light box (54) can provide automatic access to a database of images, equipped with a transceiver (56) to read identifier (50) and use the information obtained for accessing an image, such as on a networked database. The image data are obtained and displayed, allowing image (74′) to display side by side with, or overlaid with, hard copy image (74). A control processing unit (58) controls transceiver (56) in order to identify the patient data from identifier (50) or from a referenced database.

Digital light box (54) allows a careful comparison of one image against another, making it simpler to obtain images from the same angle at different times for side-by-side comparison. Digital light box (54) also makes it possible to overlay images for comparison on display screen (48).

### PARTS LIST

10. Event

20. Digital camera

22. Folder

24. X-ray

26. Admissions report

28. Lab report

30. Patient

32. Table of contents

34. Transmitter

35. Receiver

36. File

38. Printer

40. Medical professional

42. Imaging specialist

44. Keyboard console

46. Text window

48. Display screen

50. Identifier

52. Backlight portion

54. Digital light box

56. Transceiver

58. Control processing unit

60. Reader

62. Electronic display portion

64. Data entry console

70. Memory

71. Historical data

72. Photograph

74. Medical image

76. Workstation

78. Printer

80. CR plate

82. Digitizer

86. Diagnosis

88. Hardcopy output print

90. Imaging equipment

100. Initial evaluation/admissions stage

110. Image capture stage

120. Image processing stage

130. Diagnosis stage

140. Treatment stage

150. Archival stage

1. A patient information management system, comprising:
a first identifier for storing patient identification data in a remotely readable form;
a second identifier associated with a medical device for storing patient medical information in a remotely readable form; and
at least one reader for remotely reading data stored in said first and second identifiers and communicating said data to an external database.

2. A patient information management system as defined in claim 1, wherein said identifiers include radio frequency transponders, and said readers comprise transceivers adapted to communicate with said radio frequency transponders and to obtain information therefrom.

3. A patient information management system as defined in claim 2, wherein said radio frequency transponders include a passive transponder.

4. A patient information management system as defined in claim 1, wherein said medical device is a diagnostic device.

5. A patient information management system as defined in claim 4, wherein said diagnostic device is an imaging device, and said patient medical information is information concerning diagnostic images.

6. A patient information management system as defined in claim 2, wherein said first identifier includes at least two radio frequency transponders, one of which stores patient medical information.

7. A patient information management system as defined in claim 1, further comprising a third identifier for storing identification data associated with medical personnel.

8. A patient information management system as defined in claim 7, wherein said reader further remotely reads identification data regarding a medical personnel and authorizes access to said stored patient medical information.

9. A patient information management system as defined in claim 8, wherein said reader reads an identifier associated with a medical provider for preventing access to at least some of the stored data.

10. A patient information management system as defined in claim 1, further comprising a medical information recording medium including an identifier for storing patient information.

11. A patient information management system as defined in claim 10, wherein said recording medium is a medical imaging medium.

12. A patient information management system as defined in claim 2, wherein at least one of said first and second identifiers includes a plurality of Radio frequency transponders for increased memory capacity and for providing a means to sequester information.

13. A patient information management system as defined in claim 12, wherein said plurality of radio frequency transponders includes a single antenna.

14. A patient information management system as defined in claim 1, further comprising a treatment means for treating a patient including an identifier for storing treatment data in a remotely accessible form.

15. A patient information management system as defined in claim 14, wherein said treatment means includes at least one of a medical device, a pharmaceutical source, and a medical consumable.

16. A patient information management system as defined in claim 14, wherein said treatment means includes a pharmaceutical composition.

17. A patient information management system, comprising:
a patient identifier including a radio frequency transponder storing patient identification data;
a medical device including an radio frequency transponder for storing patient medical information, and at least one reader for remotely reading data stored in said radio frequency transponder for said patient identifier and said medical device and communicating said data to an external networked database.

18. A patient information management system as defined in claim 17, wherein one of said patient identifier and medical device includes a plurality of radio frequency identification transponders.

19. A patient information management system as defined in claim 18, wherein said plurality of radio frequency identification transponders includes a single antenna.

20. A patient information management system as defined in claim 17, wherein said reader also accesses medical information from said external networked database and is adapted to provide said medical information.

21. A patient information management system as defined in claim 20, wherein said reader includes a programmable lock circuit for preventing the reader from accessing selected portions of said medical data depending upon an identity of a requestor.

22. A patient information management system as defined in claim 1, wherein one of said identifiers includes a means for generating an alarm signal upon the occurrence of a pre-selected event.

23. The patient information management system of claim 17, further comprising a medical image having an radio frequency transponder associated therewith having an image identification data stored therein and said radio frequency transponder associated with the medical image has a photodiode adapted to detect when the medical image is exposed to light for use in viewing the image, said radio frequency transponder being adapted to provide an output signal indicative of such exposure and wherein said reader is adapted to remotely read such an output signal and to store exposure data in association with the medical image identification data and the patient identification data in the memory.

24. A method for managing patient information comprising the steps of:
providing a patient with a patient identifier that stores patient identification information in a remotely readable form;
recording diagnosis data for the patient in an identifier in a remotely readable form, and remotely reading the data recorded in said identifiers; and
storing the patient identification data in association with the diagnosis data in a memory.

25. The method of claim 24, further comprising the step of capturing an image of the patient and associating the image with the patient identification information.

26. The method of claim 24, further comprising the step of storing the data in an archival system.

27. The method of claim 24, further comprising the step of recording treatment data and storing the treatment data in association with the patient identification data in the memory.

28. The method of claim 24, further comprising the step of recording medical provider identification data and storing the medical provider identification data in association with the patient identification data in the memory.

29. The method of claim 24, wherein the patient identifier comprises a card provided by an insurer and includes data therein identifying insurance coverage for the patient.

30. The method of claim 24, wherein the wherein the patient identifier comprises a card provided by an insurer and contains information to facilitate admission to a medical facility.

31. The method of claim 24, further comprising the step of storing at least some of the patient treatment data in an archival system.
